(19) United States
(12) Patent Application Publication
(10) Pub. No.: US 2021/0123435 A1
(43) Pub. Date: Apr. 29, 2021

(54) FIVE CYLINDER PLUNGER PUMP WITH INTEGRAL POWER END STRUCTURE

(71) Applicant: YANTAI JEREH PETROLEUM EQUIPMENT & TECHNOLOGIES CO., LTD., Yantai (CN)

(72) Inventors: Wenping Cui, Yantai (CN); Xiaosong Wei, Yantai (CN); Haiping Cui, Yantai (CN); Yanjing Sun, Yantai (CN)

(21) Appl. No.: 16/832,890

(22) Filed: Mar. 27, 2020

(30) Foreign Application Priority Data
Oct. 29, 2019 (CN) 201911036866.7

(51) Int. Cl. F04B 53/16; F04B 1/00

(52) U.S. Cl. CPC F04B 53/16; F04B 1/00

(57) ABSTRACT

The present invention discloses a five cylinder plunger pump with an integral power end structure. In the power end assembly of the five cylinder plunger pump, the crankcase and the crosshead case adopt an integral welding structure, so that the power end assembly has a higher structural strength and a better support stability to reduce vibration of the whole pump. The cylinder spacing is 13-14 inches, increasing the bearing area of the connecting rod, the crosshead and the bearing bushes, and ensuring the high power output of the five cylinder plunger pump. The high power five cylinder plunger pump can effectively solve the problems of narrow area in shale gas fracturing wellsite and the need for multiple fracturing equipment, thus reducing the use of equipment and facilitating the arrangement of the wellsite. The long stroke design of 11 inches is beneficial to realize the operation requirement of large displacement and enhance the operation efficiency. The multi-point support design of the crankcase, the crosshead case and the hydraulic end assembly can enhance the support strength of the five cylinder plunger pump and reduce the vibration, thus better ensuring high load operation and more smoothly running.

### TECHNICAL FIELD

The present invention relates to the technical field of plunger pumps, and specifically to a five cylinder plunger pump with an integral power end structure.

### BACKGROUND

With the further development of unconventional oil and gas, shale oil and gas, pressure and displacement requirements for fracturing operations are increasing, not only the operating pressure increases with the increase of horizontal well depth, and the required displacement of a single well is getting higher and higher, so that fracturing operations become larger, and harsh operating conditions also put forward higher requirements for fracturing equipment, especially for the plunger pump. Currently, in the process of shale oil and gas development, the operating pressure is generally 80-90 MPa or even higher, and the single-stage operating displacement is also generally 1800 m³-2000 m³ or above, so the plunger pump not only should meet the high pressure continuous operation with large displacement, but also should ensure the quality stability under continuous high load operations, reducing the downtime and maintenance time of the pump. The most widely used fracturing truck on the market today is Model 2500 fracturing truck equipped with 2800 hp plunger pump, other commonly used fracturing pumps include 2500 hp pump, 3300 hp pump, 4000 hp pump and the like. Take 2800 hp pump for example, the single pump displacement is lower in high pressure operation due to power limitation. For a shale gas wellsite with a single-stage displacement demand of 14-16 m³/min, a total of nearly 20 fracturing trucks are required to operate simultaneously to meet the total fracturing displacement requirements, this will take up a large area of the wellsite, and increase the difficulty of equipment arrangement in a narrow oil and gas field wellsite. Moreover, in the face of more and more severe operating conditions for a long time of high load operations, the frequency of problems with conventional plunger pumps is also increasing, thus increasing the maintenance and repair costs. Electric drive fracturing operations have emerged in recent years, the use of motor drive has also solved the problem of power limitation of diesel engines, which is more suitable for driving high power plunger pumps.

With the increase of the plunger pump power, the operation stability of the plunger pump itself is required to be higher, especially the strength and support stability of the power end structure of the plunger pump are required to be higher.

### SUMMARY

To overcome the deficiencies in the prior art, an objective of the present invention is to provide a five cylinder plunger pump with an integral power end structure. In the power end assembly of the five cylinder plunger pump, the crankcase and the crosshead case adopt an integral welding structure, so that the power end assembly has a higher structural strength and a better support stability to reduce vibration of the whole pump. The cylinder spacing is 13-14 inches, ensuring the high power output of the five cylinder plunger pump. Specifically, the power of the five cylinder plunger pump can reach 7000 hp. The high power five cylinder plunger pump can effectively solve the problems of narrow area in shale gas fracturing wellsite and the need for multiple fracturing equipment, thus reducing the use of equipment and facilitating the arrangement of the wellsite. The long stroke design of 11 inches is beneficial to realize the operation requirement of large displacement and enhance the operation efficiency. The multi-point support design of the crankcase, the crosshead case and the hydraulic end assembly can enhance the support strength of the five cylinder plunger pump and reduce the vibration, thus better ensuring high load operation and more smoothly running. The two-stage reduction is realized by the planetary reduction gearbox and the parallel reduction gearbox in the five cylinder plunger pump to obtain a large reduction ratio. The increased reduction ratio can not only reduce the input torque, improve the service life of the reduction gearbox, and better match the selection of engine and motor; but also effectively reduce the stroke number of the five cylinder plunger pump and improve the service life of various components.

The present invention is achieved by the following technical measures: a five cylinder plunger pump with an integral power end structure, including a power end assembly, a hydraulic end assembly and a reduction gearbox assembly; one end of the power end assembly is connected to the hydraulic end assembly, the other end of the power end assembly is connected to the reduction gearbox assembly; the power end assembly includes a crankcase, a crosshead case and a spacer frame; the crankcase and the crosshead case are integrally welded to constitute a power end housing which is connected to the spacer frame; the power end housing includes a vertical plate, a bearing seat, a front end plate, a back cover plate, a base plate, a support plate and an upper cover plate; there are six vertical plates and six bearing seats, each vertical plate is connected to a corresponding bearing seat, and the six vertical plates are arranged in parallel to constitute a power end chamber; the base plate is mounted at the bottom of the power end chamber, the upper cover plate is mounted on the top of the power end chamber, the front end plate is mounted at the front end of the power end chamber, the back cover plate is mounted at the back end of the power end chamber, and the support plate is disposed between two adjacent vertical plates arranged in parallel.

Further, a crankshaft support is disposed at the bottom of the crankcase, and the crankshaft support is used to support the crankcase.

Further, a crosshead support is disposed at the bottom of the crosshead case, and the crosshead support is used to support the crosshead case.

Further, a hydraulic support is disposed at the bottom of the spacer frame, and the hydraulic support is used to support the hydraulic end assembly.

Further, the crankcase is provided with a crankshaft, the crankshaft is integrally forged from alloy steel and includes six axle journals and five bellcranks, one bellcrank is disposed between every two adjacent axle journals, and the cylinder spacing of the five cylinder plunger pump is 13-14 inches.

Further, the crankshaft is provided with a spline to which the reduction gearbox assembly is connected. Further, a crosshead assembly is disposed within the crosshead case, a connecting rod assembly is disposed between the crankcase and the crosshead case, and a crankshaft is disposed within the crankcase; one end of the connecting rod assembly is connected to the crankshaft through a connecting rod bearing bush, the other end of the connecting rod assembly is connected to the crosshead assembly through a crosshead bearing bush, and the connecting rod bearing bush and the crosshead bearing bush are both alloy coated steel backing bearing bushes.

Further, the stroke of the five cylinder plunger pump with an integral power end structure is 11 inches.

Further, the reduction gearbox assembly includes a planetary reduction gearbox and a parallel reduction gearbox, one end of the planetary reduction gearbox is connected to the power end assembly, the other end of the planetary reduction gearbox is connected to the parallel reduction gearbox, and the two-stage reduction of the reduction gearbox assembly is realized by the planetary reduction gearbox and the parallel reduction gearbox, with a reduction ratio of 8:1 to 15:1.

Compared with the prior art, the present invention has the following beneficial effects: 1. In the power end assembly of the five cylinder plunger pump, the crankcase and the crosshead case adopt an integral welding structure, so that the power end assembly has a higher structural strength and a better support stability to reduce vibration of the whole pump. 2. The cylinder spacing is 13-14 inches, increasing the bearing area of the connecting rod, the crosshead and the bearing bushes, and ensuring the high power output of the five cylinder plunger pump. Specifically, the power of the five cylinder plunger pump can reach 7000 hp. The high power five cylinder plunger pump can effectively solve the problems of narrow area in shale gas fracturing wellsite and the need for multiple fracturing equipment, thus reducing the use of equipment and facilitating the arrangement of the wellsite. 3. The long stroke design of 11 inches is beneficial to realize the operation requirement of large displacement and enhance the operation efficiency. 4. The multi-point support design of the crankcase, the crosshead case and the hydraulic end assembly can enhance the support strength of the five cylinder plunger pump and reduce the vibration, thus better ensuring high load operation and more smoothly running. 5. The two-stage reduction is realized by the planetary reduction gearbox and the parallel reduction gearbox in the five cylinder plunger pump to obtain a large reduction ratio. The increased reduction ratio can not only reduce the input torque, improve the service life of the reduction gearbox, and better match the selection of engine and motor; but also effectively reduce the stroke number of the five cylinder plunger pump and improve the service life of various components.

The present invention will be described in detail below with reference to the accompanying drawings and specific implementations.

### BRIEF DESCRIPTION OF THE DRAWINGS

FIG. 1 is a schematic structural diagram of a five cylinder plunger pump.

FIG. 2 is a schematic structural diagram of a power end assembly.

FIG. 3 is a schematic structural diagram of a power end housing.

FIG. 4 is a schematic structural diagram of a reduction gearbox assembly.

FIG. 5 is a sectional view of a planetary reduction gearbox.

FIG. 6 is a sectional view of a parallel reduction gearbox.

FIG. 7 is a schematic structural diagram of a crankshaft.

FIG. 8 is a schematic structural diagram of the connection between the connecting rod assembly and the crosshead assembly.

Wherein, 1. power end assembly, 2. reduction gearbox assembly, 3. hydraulic end assembly, 4. driving flange, 5. power end housing, 6. crankshaft, 7. bearing, 8. connecting rod bearing bush, 9. connecting rod body, 10. slide rail, 11. crosshead, 12. crosshead bearing bush, 13. pull rod, 14. spacer frame, 15. long screw, 16. nut, 17. clamp, 18. plunger, 19. valve housing, 20. crankshaft support, 21. crosshead support, 22. hydraulic support, 23. back cover plate, 24. vertical plate, 25.

bearing seat, 26. base plate, 27. support plate, 28. front end plate, 29. upper cover plate, 30. parallel reduction gearbox, 31. planetary reduction gearbox, 32. inner gear ring, 33. planetary gear, 34. sun gear, 35. planetary carrier, 36. bull gear, 37. pinion, 38. spline, 39. connecting rod cap, 40. connecting rod bolt, 41. crosshead gland, 42. guide plate, 43. screw.

### DESCRIPTION OF THE EMBODIMENTS

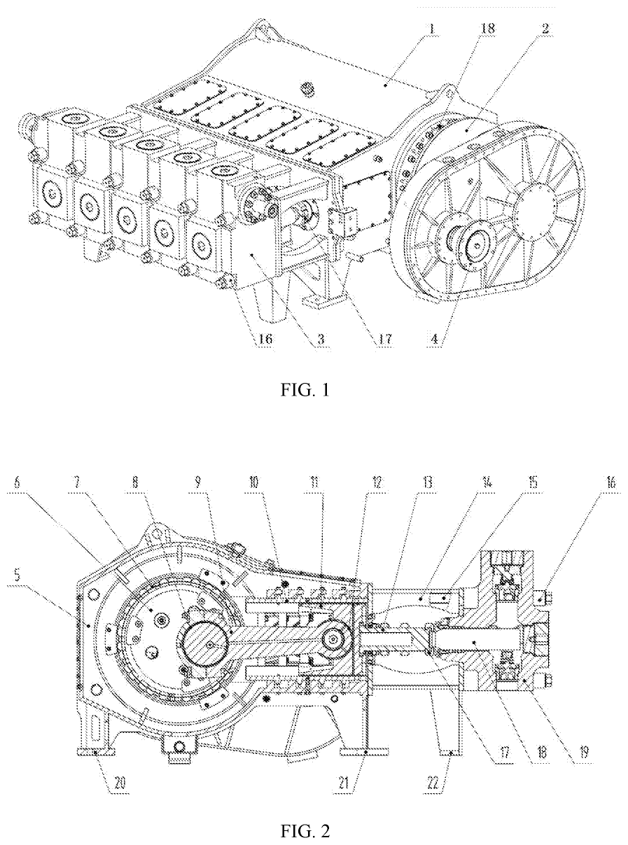

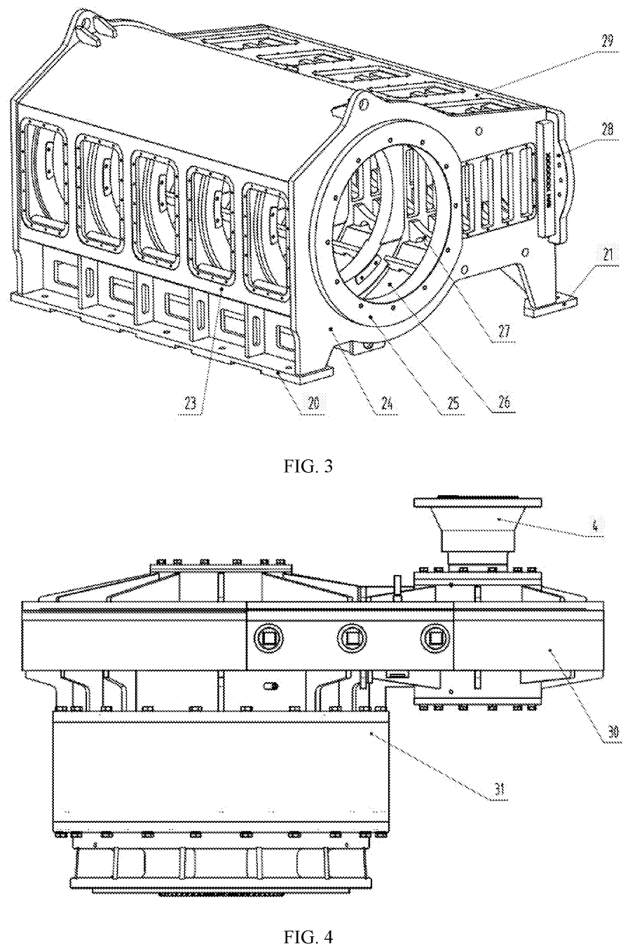

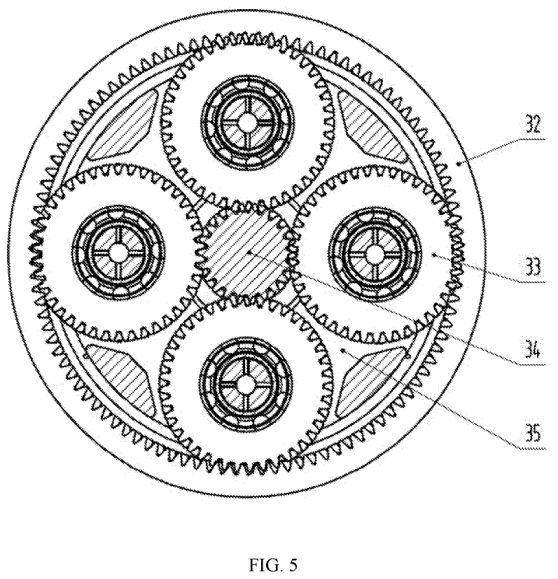

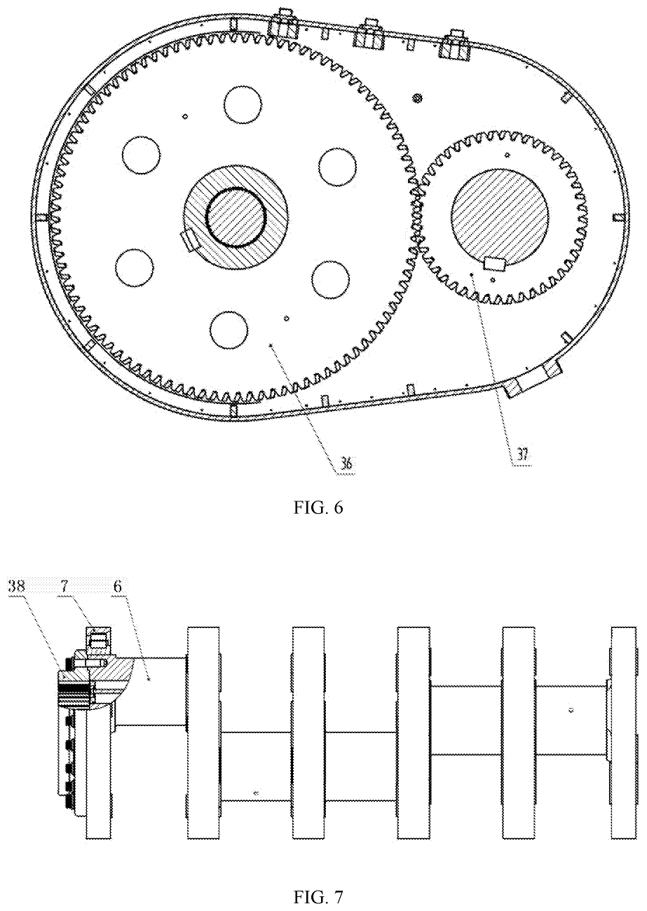

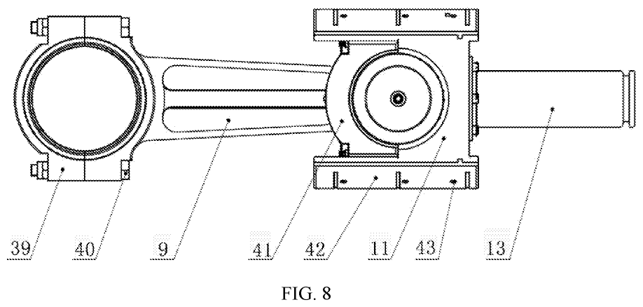

As shown in FIGS. 1 to 8, a five cylinder plunger pump with an integral power end structure, including a power end assembly 1, a hydraulic end assembly 3 and a reduction gearbox assembly 2, one end of the power end assembly 1 is connected to the hydraulic end assembly 3, the other end of the power end assembly 1 is connected to the reduction gearbox assembly 2; the power end assembly 1 includes a crankcase, a crosshead case and a spacer frame 14, the crankcase and the crosshead case are integrally welded to constitute a power end housing 5 which is connected to the spacer frame 14, the power end housing 5 includes a vertical plate 24, a bearing seat 25, a front end plate 28, a back cover plate 23, a base plate 26, a support plate 27 and an upper cover plate 29; there are six vertical plates 24 and six bearing seats 25, each vertical plate 24 is connected to a corresponding bearing seat 25, and the six vertical plates 24 are arranged in parallel to constitute a power end chamber; the base plate 26 is mounted at the bottom of the power end chamber, the upper cover plate 29 is mounted on the top of the power end chamber, the front end plate 28 is mounted at the front end of the power end chamber, the back cover plate 23 is mounted at the back end of the power end chamber, and the support plate 27 is disposed between two adjacent vertical plates 24 arranged in parallel. In the power end assembly 1 of the five cylinder plunger pump, the crankcase and the crosshead case adopt an integral welding structure, so that the power end assembly 1 has a higher structural strength and a better support stability to effectively reduce the bearing deformation of the power end housing 5, reduce the vibration of the whole pump, and improve the smoothly running of the five cylinder plunger pump.

A crankshaft support 20 is disposed at the bottom of the crankcase, the crankshaft support 20 is used to support the crankcase. A crosshead support 21 is disposed at the bottom of the crosshead case, the crosshead support 21 is used to support the crosshead case. A hydraulic support 22 is disposed at the bottom of the spacer frame 14, the hydraulic support 22 is used to support the hydraulic end assembly 3. The five cylinder plunger pump adopts a multi-point support design to enhance the support strength of the five cylinder plunger pump and reduce the vibration, thus better ensuring high load operation and more smoothly running.

The crankcase is provided with a crankshaft 6 and a bearing 7, the crankshaft 6 is integrally forged from alloy steel and includes six axle journals and five bellcranks, one bellcrank is disposed between every two adjacent axle journals. The cylinder spacing of the five cylinder plunger pump is 13-14 inches, the increased cylinder spacing design is beneficial to increase the contact area between the crankshaft 6 and the connecting rod bearing bush 8, the crosshead 11 and the slide rail 10, thus improving the support strength and ensuring the high power output of the five cylinder plunger pump. The high power five cylinder plunger pump can effectively solve the problems of narrow area in shale gas fracturing wellsite and the need for multiple fracturing equipment, thus reducing the use of equipment and facilitating the arrangement of the wellsite. There are six bearings 7 mounted on the six axle journals, meanwhile the outer rings of the bearings 7 are equipped on the six bearing seats 25 of the power end housing 5, and the bearings 7 can move rotationally within the bearing seats 25.

A spline 38 is disposed within the crankshaft 6. The reduction gearbox assembly 2 is connected to the power end housing 5 through bolts. The reduction gearbox assembly 2 is provided with an external spline which is connected to the spline 38 for power output. The installation angle of the reduction gearbox assembly 2 can be adjusted according to input requirements. A driving flange 4 is disposed outside the reduction gearbox assembly 2, through which an external power source is connected for power input.

A crosshead assembly is disposed within the crosshead case, a connecting rod assembly is disposed between the crankcase and the crosshead case, and a crankshaft 6 is disposed within the crankcase; one end of the connecting rod assembly is connected to the crankshaft 6 through the connecting rod bearing bush 8, the other end of the connecting rod assembly is connected to the crosshead assembly through the crosshead bearing bush 12, achieving a reciprocating oscillation, and the other end of the crosshead assembly is connected to the pull rod 13. The pull rod 13 is a hollow structure. The connecting rod bearing bush 8 and the crosshead bearing bush 12 are both alloy coated steel backing bearing bushes, with a large width-to-diameter ratio and a high support strength.

There are two slide rails 10 fixed on the support plate 27 within the power end housing 5. The two slide rails 10 form a semi-circular space where the crosshead 11 is mounted to allow for a linear reciprocating motion.

The crosshead assembly has a separable structure, including a crosshead gland 41 and a crosshead 11 which are connected to each other, to allow for being assembled with and disassembled from the connecting rod assembly.

The connecting rod assembly includes a connecting rod cap 39 and a connecting rod body 9, which are made by integral forging and cutting, with a high strength. The connecting rod cap 39 and the connecting rod body 9 are connected to each other through bolts. Specifically, one end of the connecting rod body 9 is connected to the bellcrank sequentially through the connecting rod cap 39, the connecting rod bolt 40 and the connecting rod bearing bush 8, and the other end of the connecting rod body 9 is connected to the crosshead 11 through the crosshead gland 41 and the crosshead bearing bush 12. The upper and lower ends of the crosshead 11 are fixed with guide plates 42 through screws 43 respectively. The guide plates 42 are made of copper alloy, and contact with the slide rails 10 directly for relative motion.

The crankshaft 6, the connecting rod body 9, and the crosshead 11 are all provided with lubricating oil lines for the lubrication of the bearing 7, the connecting rod bearing bush 8, and the crosshead bearing bush 12, respectively.

The hydraulic end assembly 3 includes a valve housing 19, a plunger 18, a clamp 17 and the like. The hydraulic end assembly 3 connects the plunger 18 to the pull rod 13 through the clamp 17, and fixes them on the spacer frame 14 with a long screw 15 and a nut 16, the long screw 15 is connected to the power end housing 5 through screw threads.

The five cylinder plunger pump with an integral power end structure has a stroke of 11 inches. The long stroke design is very suitable for the current shale gas fracturing chain operation requirements, reducing the number of equipment in the wellsite, and raising operational efficiency and economy.

The reduction gearbox assembly 2 includes a planetary reduction gearbox 31 and a parallel reduction gearbox 30. One end of the planetary reduction gearbox 31 is connected to the power end assembly 1, the other end of the planetary reduction gearbox 31 is connected to the parallel reduction gearbox 30. The two-stage reduction of the reduction gearbox assembly 2 is realized by the planetary reduction gearbox 31 and the parallel reduction gearbox 30, with a reduction ratio of 8:1 to 15:1. The parallel reduction gearbox 30 includes a bull gear 36 and a pinion 37, for the first-stage reduction; The planetary reduction gearbox 31 includes an inner gear ring 32, four planetary gears 33, a sun gear 34, and a planetary carrier 35 to form a planetary gear mechanism for the second-stage reduction. The sun gear 34 is located at the center of the planetary gear mechanism, engages with the planetary gear 33, and is coaxial with the bull gear 36 of the parallel reduction gearbox 30. In running, an external power source is connected through a driving flange 4 to drive the input shaft to rotate, the rotation is transferred to the bull gear 36 through the pinion 37 for the first-stage reduction, and transferred to the sun gear 34 through the bull gear 36. The sun gear 34 drives the planetary carrier 35 through the planetary gear 33 for the second-stage reduction, and finally transfers the power to the crankshaft 6 through a spline 38. The two-stage reduction is useful for gaining a large transmission ratio, thus effectively reducing the input torque, and decreasing the stroke number of the pump.

Operating principle: An external power or rotating speed drives the reduction gearbox assembly 2 to rotate through the driving flange 4. Power and torque are transferred to the crankshaft 6 through the spline 38 by the two-stage reduction. The crankshaft 6 and the bearing 7 rotate within the power end housing 5, driving the motion of the connecting rod body 9, the crosshead 11 and the pull rod 13, converting the rotational motion of the crankshaft 6 into the reciprocating linear motion of the pull rod 13. The pull rod 13 drives the plunger 18 through a clamp 17 to move back and forth within the valve housing 19, thus realizing the low pressure liquid suction and high pressure liquid discharge, i.e, realizing the pumping of liquid.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A quintuplex plunger pump with an integral power end structure, comprising a power end assembly, a hydraulic end assembly and a reduction gearbox assembly, one end of the power end assembly is connected to the hydraulic end assembly, the other end of the power end assembly is connected to the reduction gearbox assembly, wherein the power end assembly comprises a crankcase, a crosshead case and a spacer frame, the crankcase and the crosshead case are integrally welded to constitute a power end housing which is connected to the spacer frame, the power end housing comprises six vertical plates, six bearing seats, a front end plate, a back cover plate, one base plate, a support plate and one upper cover plate, each vertical plate is connected to a corresponding bearing seat, and the six vertical plates are arranged in parallel to constitute a power end chamber, the base plate is mounted at the bottom of the power end chamber, the upper cover plate is mounted on the top of the power end chamber, the front end plate is mounted at the front end of the power end chamber, the back cover plate is mounted at the back end of the power end chamber, and the support plate is disposed between two adjacent vertical plates arranged in parallel.

2. The quintuplex plunger pump with an integral power end structure according to claim 1, wherein a crankshaft support is disposed at the bottom of the crankcase, and the crankshaft support is used to support the crankcase.

3. The quintuplex plunger pump with an integral power end structure according to claim 1, wherein a crosshead support is disposed at the bottom of the crosshead case, and the crosshead support is used to support the crosshead case.

4. The quintuplex plunger pump with an integral power end structure according to claim 1, wherein a hydraulic support is disposed at the bottom of the spacer frame, and the hydraulic support is used to support the hydraulic end assembly.

5. The quintuplex plunger pump with an integral power end structure according to claim 1, wherein the crankcase is provided with a crankshaft, the crankshaft is integrally forged from alloy steel and comprises six axle journals and five bellcranks, one bellcrank is disposed between every two adjacent axle journals, and the cylinder spacing of the quintuplex plunger pump is 13-14 inches.

6. The quintuplex plunger pump with an integral power end structure according to claim 5, wherein the crankshaft is provided with a spline to which the reduction gearbox assembly is connected.

7. The quintuplex plunger pump with an integral power end structure according to claim 1, wherein a crosshead assembly is disposed within the crosshead case, a connecting rod assembly is disposed between the crankcase and the crosshead case, and a crankshaft is disposed within the crankcase, one end of the connecting rod assembly is connected to the crankshaft through a connecting rod bearing bush, the other end of the connecting rod assembly is connected to the crosshead assembly through a crosshead bearing bush, and the connecting rod bearing bush and the crosshead bearing bush are both alloy coated steel backing bearing bushes.

8. The quintuplex plunger pump with an integral power end structure according to claim 1, wherein the stroke of the quintuplex plunger pump with an integral power end structure is 11 inches.

9. The quintuplex plunger pump with an integral power end structure according to claim 1, wherein the reduction gearbox assembly comprises a planetary reduction gearbox and a parallel reduction gearbox, one end of the planetary reduction gearbox is connected to the power end assembly, the other end of the planetary reduction gearbox is connected to the parallel reduction gearbox, and the two-stage reduction of the reduction gearbox assembly is realized by the planetary reduction gearbox and the parallel reduction gearbox, with a reduction ratio of 8:1 to 15:1.
